(19) United States
(12) Patent Application Publication
(10) Pub. No.: US 2025/0113173 A1
(43) Pub. Date: Apr. 3, 2025

(54) MOBILITY HANDLING IN AMBIENT INTERNET OF THINGS

(71) Applicant: Nokia Technologies Oy, Espoo (FI)

(72) Inventors: Yong Gang WANG, Shanghai (CN); Muhammad Majid BUTT, Naperville, IL (US); Ahlem KHLASS, Massy (FR); Navin HATHIRAMANI, Coppell, TX (US); Nitin MANGALVEDHE, Hoffman Estates, IL (US)

(21) Appl. No.: 18/891,023

(22) Filed: Sep. 20, 2024

(30) Foreign Application Priority Data
Sep. 28, 2023 (WO) PCT/CN2023/122999

(51) Int. Cl. H04W 8/18; H04B 7/22; H04B 17/318

(52) U.S. Cl. CPC H04W 8/18; H04B 7/22; H04B 17/318

(57) ABSTRACT

Embodiments of the present disclosure relate to apparatuses, methods, devices and computer readable storage medium for device measurement based mobility handling in ambient internet of things. The method including at a first apparatus, the first apparatus receives, from a second apparatus, a polling signal at least indicating an identifier of the second apparatus and a period of a polling cycle of the polling signal, wherein the first apparatus enables a communication with the second apparatus by backscattering mechanism; the first apparatus determines a query occasion for a backscattering communication; and the first apparatus initiates, according to the identifier of the second apparatus, an attachment procedure to the second apparatus based on at least one of: a signal strength measurement on the polling signal, or the query occasion of the backscattering communication.

### FIELDS

Various example embodiments of the present disclosure generally relate to the field of telecommunication and in particular, to apparatuses, methods, devices and computer readable storage medium for mobility handling in ambient internet of things (AIoT).

### BACKGROUND

Energy harvesting enabled communication services, also called AIoT in the 3rd Generation Partnership Project (3GPP), have been widely used in various vertical industries including logistics, manufacture, transportation, energy industry etc. Enabling AIoT devices, in both public and private networks would benefit the whole 5th generation (5G) ecosystem. Therefore, support of Passive/Ambient IoT using either battery-less terminal or terminal with limited energy storage capability (e.g., using a capacitor), could become a new requirement for the existing 3GPP technologies.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, a polling signal at least indicating an identifier of the second apparatus and a period of a polling cycle of the polling signal, wherein the first apparatus enables a communication with the second apparatus by backscattering mechanism; determine a query occasion for a backscattering communication; and initiate, according to the identifier of the second apparatus, an attachment procedure to the second apparatus based on at least one of: a signal strength measurement on the polling signal, or the query occasion of the backscattering communication.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, a polling signal at least indicating an identifier of the second apparatus and a period of a polling cycle of the polling signal from the second apparatus, wherein the first apparatus enables a communication with the second apparatus by an energy harvesting; and perform an attachment procedure for the first apparatus to the second apparatus based on a response generated by the first apparatus at least based on a signal strength measurement on the polling signal.

In a third aspect of the present disclosure, there is provided a method. The method comprises: receiving, at a first apparatus from a second apparatus, a polling signal at least indicating an identifier of the second apparatus and a period of a polling cycle of the polling signal, wherein the first apparatus enables a communication with the second apparatus by backscattering mechanism; determining a query occasion for a backscattering communication; and initiating, according to the identifier of the second apparatus, an attachment procedure to the second apparatus based on at least one of: a signal strength measurement on the polling signal, or the query occasion of the backscattering communication.

In a fourth aspect of the present disclosure, there is provided a method. The method comprises: transmitting, from a second apparatus to a first apparatus, a polling signal at least indicating an identifier of the second apparatus and a period of a polling cycle of the polling signal from the second apparatus, wherein the first apparatus enables a communication with the second apparatus by an energy harvesting; and performing an attachment procedure for the first apparatus to the second apparatus based on a response generated by the first apparatus at least based on a signal strength measurement on the polling signal.

In a fifth aspect of the present disclosure, there is provided a first apparatus. The first apparatus comprises means for receiving, from a second apparatus, a polling signal at least indicating an identifier of the second apparatus and a period of a polling cycle of the polling signal, wherein the first apparatus enables a communication with the second apparatus by backscattering mechanism; means for determining a query occasion for a backscattering communication; and means for initiating, according to the identifier of the second apparatus, an attachment procedure to the second apparatus based on at least one of: a signal strength measurement on the polling signal, or the query occasion of the backscattering communication.

In a sixth aspect of the present disclosure, there is provided a second apparatus. The second apparatus comprises means for transmitting, to a first apparatus, a polling signal at least indicating an identifier of the second apparatus and a period of a polling cycle of the polling signal from the second apparatus, wherein the first apparatus enables a communication with the second apparatus by an energy harvesting; and means for performing an attachment procedure for the first apparatus to the second apparatus based on a response generated by the first apparatus at least based on a signal strength measurement on the polling signal.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart of an example process of attachment to a second apparatus according to some example embodiments of the present disclosure;

FIG. 3 illustrates an example format of polling signal according to some example embodiments of the present disclosure;

FIG. 4 illustrates a signaling chart of an example process of attachment from a third apparatus to a second apparatus according to some example embodiments of the present disclosure;

FIG. 5 illustrates an example process of a time stamp-based attachment according to some example embodiments of the present disclosure;

FIG. 6 illustrates an example process of a counter-based attachment according to some example embodiments of the present disclosure;

FIG. 7 illustrates a flowchart of a method implemented at a first apparatus according to some example embodiments of the present disclosure;

FIG. 8 illustrates a flowchart of a method implemented at a second apparatus according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

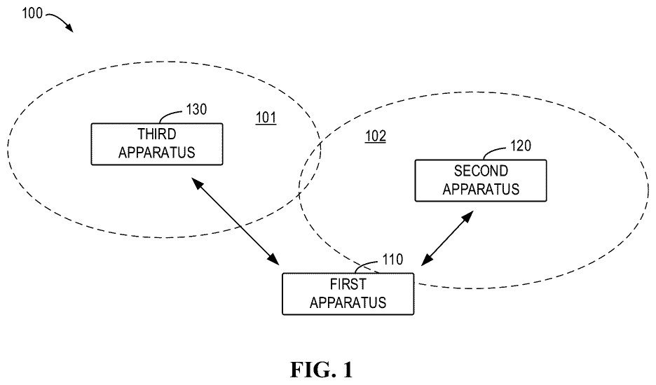

FIG. 1 illustrates an example communication environment 100 in which example embodiments of the present disclosure can be implemented. As shown in FIG. 1, the communication environment 100 may include a first apparatus 110, a second apparatus 120 and a third apparatus 130. The first apparatus 110 may communicate with the second apparatus 120 within a coverage area 102 and/or the third apparatus 130 within a coverage area 101.

The first apparatus 110 may be operated as an IoT device. In some scenarios, the first apparatus 110 may be based on energy harvesting and may operate in a passive mode and harvest energy from both 3GPP and non-3GPP devices. For example, the first apparatus 110 may use energy harvested from wireless radio waves, solar/light or any other form of energy that can be harvested in its deployment scenario and may be expected to operate with ultra-low power in the range from tens of microwatts to hundreds of microwatts.

As an example, the first apparatus 110 may harvest energy and then use an active circuit to transmit data like a transmitter. As another example, the first apparatus 110 may be operated as a passive device and use backscattering to transmit information.

As shown in FIG. 1, the first apparatus 110 located in the coverage area 101 may be illuminated by energy signals from the third apparatus 130 and backscatter information to the third apparatus 130. The first apparatus 110 located in the coverage area 102 may be illuminated by energy signals from the second apparatus 120 and backscatter information to the second apparatus 120.

In some scenarios, the first apparatus 110 may be operated as AIoT device (e.g., tag). The second apparatus 120 and/or the third apparatus 130 may be operated as a radio terminal device (e.g., UE, which may also be referred to as reader and/or activator or fixed receiver etc.). As another option, the second apparatus 120 and/or the third apparatus 130 may also be operated as a RAN device (e.g., a gNB, a BS or a eNB).

In some scenarios, the communication environment 100 may include a fourth apparatus (not shown in FIG. 1). If the second apparatus 120 is operated as a radio terminal device, the fourth apparatus may be considered as a RAN device (e.g., a gNB) associated with the second apparatus 120. In some embodiments, e.g., when the second apparatus 120 is operated as a RAN device, the fourth apparatus may be considered as a same apparatus with the second apparatus 120.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As discussed above, an AIoT device may use energy harvested from wireless radio waves or any other form of energy that can be harvested in its particular deployment scenario and may be expected to operate with ultra-low power in the range from tens of microwatts to hundreds of microwatts. For example, if energy is harvested from wireless radio waves, the output power of energy harvester would be from several micro-watt to tens of micro-watt. If solar panel is used for energy harvesting from solar/light, the output power would be less than 1 milli-watt due to the small size of the solar panel.

With reference to FIG. 1, a backscattering energy harvesting IoT system may include the first apparatus 110 (e.g., an AIoT device). The first apparatus 110 may be illuminated by energy signals and backscatter information to the second apparatus 120 or the third apparatus 130 (e.g., activators). Illumination and signal reception can be performed by the same device (referred to as monostatic configuration) or different devices (referred to as bistatic configuration).

The first apparatus 110 (e.g., an AIoT device) may have very strict energy constraints. For example, An AIoT device is connected/attached with a network through a particular reader (i.e., monostatic) or activator/reader pair (i.e., bistatic). Continuous mobility tracking for the AIoT device is not required. Even though, the AIoT device may not be always statically located at one position.

Furthermore, the first apparatus 110 (e.g., an AIoT device) may have limited device capabilities. So, the first apparatus 110 has no capability to detect the timing Reference Signal (RS) defined by 3GPP from the broadband signal and measure the Reference Signal Received Power (RSRP) on the forward channel. Only the signaling received from the activator can indicate status of the AIoT device. The activator and network can recognize the AIoT device by the response from the AIoT device.

Due to activator/AIoT device mobility, the network may no longer be able to connect to the AIoT device through the activator to which it is attached. As “make before break” functionality is not required for such devices which support use cases like warehouse inventory management, smart agriculture; there is no need to allocate resources in advance and develop mechanisms to maintain continuous connectivity.

In case of discontinuous AIoT device management, the attachment problem has two parts. One part is how to realize that connectivity with the originally attached activator has lost, and the other part is how to start a reattachment process.

As the AIoT device has specific connectivity and mobility requirements, AIoT devices should not be treated as NR UEs. Some procedures and functionalities need to be improved and/or re-designed to ensure their connectivity in 3GPP cellular networks and to solve the problem of AIoT device mobility.

The example embodiments of the present disclosure propose a new solution in which the AIoT device initiates an attachment procedure based on its measurements to handle activator/AIoT device mobility. According to some example embodiments of the present disclosure, the first apparatus 110 receives, from a second apparatus 120, a polling signal, which at least indicates an identifier of the second apparatus 120 and a period of a polling cycle of the polling signal. The first apparatus 110 enables a communication with the second apparatus 120 by backscattering mechanism. The first apparatus 110 determines a query occasion for a backscattering communication. Further, the first apparatus 110 initiates, according to the identifier of the second apparatus, an attachment procedure to the second apparatus 120 based on a signal strength measurement on the polling signal and/or the query occasion of the backscattering communication.

In this way, the first apparatus 110 may proactively measure signal receiving power from other activators and may attach to the activator actively when it is almost lost from the network, which may reduce the complexity of the tag attachment procedure.

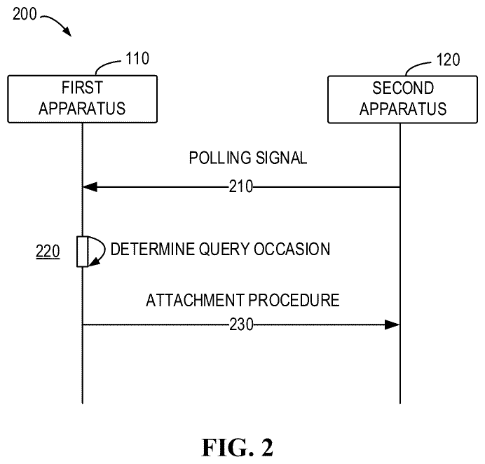

Reference is now made to FIG. 2, which illustrates a signaling chart 200 of an example process of an attachment from the first apparatus 110 to a second apparatus 120 according to some example embodiments of the present disclosure. As shown in FIG. 2, the signaling chart 200 involves the first apparatus 110 and the second apparatus 120.

As shown in FIG. 2, the first apparatus 110 receives (210) a polling signal from the second apparatus 120. For example, the second apparatus 120 may broadcast the polling signal to all the AIoT devices in its coverage area. In some examples, the polling signal is a narrowband signal in time domain and much simpler than a Reference Signal (RS) in 3GPP. For example, the polling signal is a low-rate signal detected and may be measured in the analog domain.

As described above, the second apparatus 120 may be operated as a gNB or an UE. The polling signal may be transmitted from the second apparatus 120. A gNB may be able to illuminate all AIoT devices in a cell, and a UE is to illuminate the AIoT devices in its coverage area. It is to be understood that it is possible that certain AIoT devices are too far away from the gNB for the gNB to illuminate them.

The polling signal may indicate the identification information of the second apparatus 120, e.g., an identifier of the second apparatus 120. That is, the first apparatus 110, upon receiving the polling signal, may recognize the second apparatus 120.

The polling signal may further indicate a period of a polling cycle of the polling signal from the second apparatus 120. In other words, the polling signal is periodic, and its periodicity may be defined in the polling signal.

It is to be understood that polling signals of different apparatuses may be staggered in time and do not interfere with each other. The polling signal of each apparatus may be unique. For example, there are a plurality of second apparatuses in the environment where the first apparatus 110 is deployed. The plurality of second apparatuses has a unique polling signal individually.

In some example embodiments, the polling signal may further indicate at least one of the following: an identifier of a cell associated with the second apparatus 120, information of time reference, or an indication for requesting identification information of the first apparatus 110.

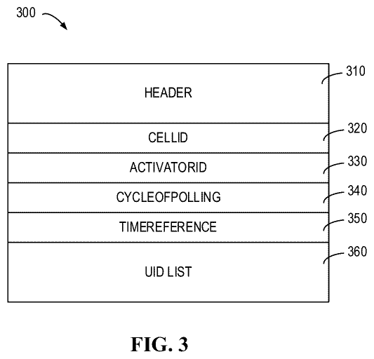

Reference is now made to FIG. 3, which illustrates an example format of polling signal 300 according to some example embodiments of the present disclosure. As shown in FIG. 3, the polling signal 300 involves a field 310 indicating a header of the polling signal.

Furthermore, the polling signal 300 may include one or more fields indicating a source from which the polling signal is received, e.g., the field 320 indicates an identifier of a cell associated with the second apparatus 120 and the field 330 indicates an identifier of the second apparatus 120 (e.g., activator).

As described, the polling signal 300 may include a field associated with a periodicity of the polling cycle, e.g., the field 340 indicates a period of the polling cycle called as “cylceOfPolling”. Moreover, the polling signal 300 may include a field indicating time reference for the first apparatus 110, e.g., the field 350 “timeReference”.

As shown, the fields associated with time, i.e., fields 340 “cylceOfPolling” and 350 “timeReference”, are introduced to the polling signal. The AIoT device has no internal clock since cheap oscillators are also very inaccurate and anyway also need continued power source. In some examples, the “time” value may be always provided by the activator. The “timeReference” indicates a kind of “time” for the AIoT device to be aware of some occasions, for example query occasions.

In one example embodiment, the “timeReference” may be defined as the absolute time stamp of current time. In another example embodiment, the “timeReference” may be defined as the hyperframe number at polling signal transmission moment.

Optionally or additionally, the polling signal 300 may include a field 360 indicating one or more IDs of respective apparatus(es) 110. That is, the second apparatus 120 may expect these apparatus(es) 110 to report its/their status.

As an example, the second apparatus 120 may broadcast the polling signal to all first apparatus(es) 110 (e.g., AIoT device(s)) in its coverage area. In this case, the polling signal may not need to include the field 360. If the second apparatus 120 intends to broadcast the polling signal to certain first apparatus(es) 110 (e.g., AIoT device(s)) and expect to receive the signal from the certain first apparatus(es) 110, the polling signal may indicate a list of identifiers of the certain first apparatus(es) 110.

In a scenario of the process shown in FIG. 2, the first apparatus 110 may enable a communication with the second apparatus 120 by backscattering mechanism. Using backscattering mechanism, the first apparatus 110 does not need the energy support of the battery, and therefore does not add a crystal oscillator to provide frequency and time reference. In this way, its cost and complexity can remain very low.

Now the reference is back to FIG. 2, the first apparatus 110 determines (220) a query occasion for a backscattering communication. It is assumed that the first apparatus 110 has no battery and no oscillator. In order to obtain a time reference, the first apparatus 110 may record its query cycle and the last time (query occasion) when it was queried. Network may periodically query the data of a sensor on the first apparatus 110, and the periodicity may be defined by the query cycle. The moment of query is defined as a query occasion.

According to the identifier of the second apparatus 120, then the first apparatus 110 initiates (230) an attachment procedure to the second apparatus 120 based on a signal strength measurement on the polling signal and/or the query occasion of the backscattering communication.

As an example, the first apparatus 110 may measure the strength of the polling signal. This may be done, for example, by activating an energy measurement module for a short, fixed duration after detecting the polling signal.

Based on the measured signal strength, the first apparatus 110 may determine whether it can attach with a new activator or maintain the attachment with the original activator (if it exists). For example, if the first apparatus 110 determines that the measured signal strength of a polling signal received from the second apparatus 120 satisfies a threshold value (e.g., exceeds the threshold value), the first apparatus 110 may initiate the attachment procedure to the second apparatus 120.

For example, before the measurement on the polling signal received from second apparatus 120, the first apparatus 110 may measure a signal strength of a polling signal from an original activator (if it exists) and determine that the signal strength of the polling signal from the original activator do not satisfy the threshold value.

If the first apparatus 110 determines that the measured signal strength of a polling signal received from the second apparatus 120 does not satisfy (e.g., is lower than the threshold value), the first apparatus 110 may attempt to receive the polling signal from other activator until it finds one with a satisfied signal strength. In this case, the first apparatus 110 may lose the polling signal from the original activator.

As another example, in addition to the measured signal strength (e.g., a Signal Receiving Power (SRP) and/or a Signal to Interference plus Noise Ratio (SINR)) of the polling signal, the first apparatus 110 may also consider a duration of a query occasion and determine whether the attachment procedure to the second apparatus 120 is to be initiated. For example, in a case where the measured signal strength satisfies a threshold value, the first apparatus 110 may continue with its attachment to the second apparatus 120 if the time to the next query occasion meets a predetermined condition. This case may be further described in detail as below.

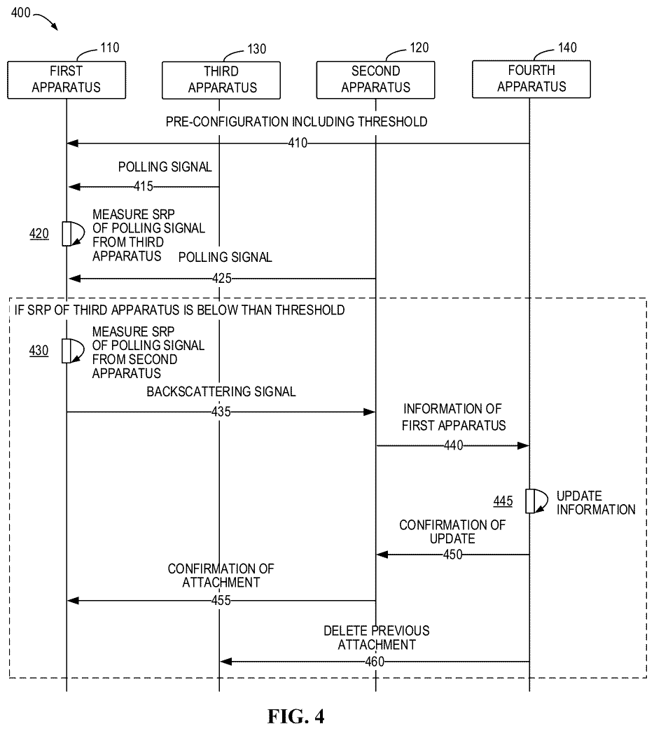

Reference is now made to FIG. 4, which illustrates a signaling chart 400 of an example process of (re)attachment to the second apparatus 120 (e.g., from the third apparatus 130) according to some example embodiments of the present disclosure. As shown in FIG. 4, the signaling chart 400 involves the first apparatus 110, the second apparatus 120, the third apparatus 130 and the fourth apparatus 405. The first apparatus 110 has established the attachment to the third apparatus 130. In some cases, the fourth apparatus 405 has the cell associated with the second apparatus 120 and the third apparatus 130.

As shown in FIG. 4, the first apparatus 110 may receive (410) pre-configuration including threshold, e.g., a threshold of an SRP or a threshold of an SINR, from the fourth apparatus 405. The threshold pre-configured to the first apparatus 110 may be used to identify better apparatus (e.g., activators/readers) than the assigned one. The pre-configuration information may be broadcast by the fourth apparatus 405 (e.g., a gNB) via the system information (e.g., a System Information Block (SIB)) or broadcast by activators which is forwarded from gNB.

The third apparatus 130 may broadcast the periodic polling signal including the information of polling cycle and the current time at the time of signal transmission, i.e., time reference. The first apparatus 110 may receive (415) the polling signal from the third apparatus 130. At this point, the third apparatus 130 may be the original/assigned attached apparatus for the first apparatus 110.

Furthermore, the second apparatus 120 may also broadcast the periodic polling signal including polling cycle and time reference and the first apparatus 110 may receive (425) the polling signal from the second apparatus 120.

The first apparatus 110 may measure (420) the SRP of the polling signal from the third apparatus 130.

If the first apparatus 110 determines that the SRP of the polling signal from the third apparatus 130 is lower than a first threshold value, the first apparatus 110 may determine that the first apparatus may be away from the coverage area of the third apparatus 130. Then the first apparatus 110 may attempt to measure (430) the SRP of the polling signal from other apparatus, e.g., from the second apparatus 120.

If the first apparatus 110 determines that the SRP of the polling signal from the third apparatus 130 equals to or exceeds a first threshold value, the first apparatus 110 may maintain the attachment to the third apparatus 130.

If the first apparatus 110 determines that the measured signal strength, e.g., the SRP, of the polling signal received from the second apparatus 120 satisfies (e.g., exceeds) a second threshold value, the first apparatus 110 may determine whether the time to the next query occasion is less than a predefined time, for example N polling cycles. If so, the first apparatus 110 may initiate the attachment to the second apparatus 120. For example, as shown in FIG. 4, the first apparatus 110 may backscatter (435), to the second apparatus 120, the polling signal and modulate the response message (e.g., UID and any other assistance information to be used for attachment).

If the time to the next query is more than the predefined N polling cycles, the first apparatus 110 may ignore the measured signal strength of the polling signal from the second apparatus 120 and wait the next polling cycle to receive a further polling signal from the second apparatus 120.

Upon receiving the backscattering signal from the first apparatus 110, the second apparatus 120 may transmit (440) the information (e.g., UID, power) of the first apparatus 110 to the fourth apparatus 405. Then, the fourth apparatus 405 may update (445) the information in the records (e.g., activator ID and UID). The fourth apparatus 405 may transmit (450) a confirmation of the updating to the second apparatus 120.

Then the second apparatus 120 may transmit (455) a confirmation of the attachment to the first apparatus 110. The fourth apparatus 405 may delete (460) previous attachment associated with the third apparatus 130.

That is, the fourth apparatus 405 may performs re-attachment of the first apparatus 110 with the second apparatus 120 and updates the records in the context of the first apparatus 110. The fourth apparatus 405 may send the confirm/ACK message to the second apparatus 120 and deletes the previous attachment record of third apparatus 130.

According to the example embodiments described above, the establishment of attachment can be delayed to avoid frequent de-attachment/re-attachment between activators due to the AIoT device moving. This is the key difference from the handover in LTE/NR for normal UE. Because the interval between queries may be very long, the AIoT device may move to a site far away from the original activator or even far away from the original cell between two query occasions. When the AIoT device enters a new activator coverage area, if it needs to initiate the re-attachment anyway, the signaling overhead and interference to other AIoT devices and normal UEs are unnecessary. In fact, it only needs to establish the re-attachment just before the next query occasion.

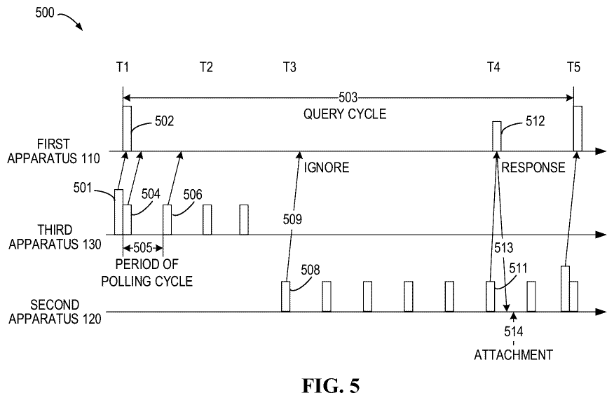

As described above, the first apparatus 110 may determine, in a case where the first apparatus 110 determines a measured signal strength of a polling signal received from a second apparatus 120 satisfies a threshold, whether an attachment procedure to the second apparatus is to be initiated based on a determination of a subsequent query occasion of the first apparatus 110. For example, the subsequent query occasion may be determined by the first apparatus 110 based on the period of the query cycle, which will be described with reference to FIG. 5 as below.

FIG. 5 illustrates an example process 500 of absolute time stamp-based attachment according to some example embodiments of the present disclosure. As shown in FIG. 5, the first apparatus 110 may be attached to the third apparatus 130. A query occasion 503 starts from the time point T1 and ends at the time point T5 (e.g., 30 minutes). That is, the third apparatus 130 may send the query request once per 30 minutes. The period of polling cycle 505 is for example 1 minute. That is, the third apparatus 130 may send its own polling signal once per 1 minute.

The third apparatus 130 sends a query 501. The first apparatus 110 receives the query 501 and backscatters a query response 502 at the time point T1. The third apparatus 130 may send, to the first apparatus 110, polling signals periodically according to the period of polling cycle 505, for example, a polling signal 504, a polling signal 506 and so on.

Due to the movement, the first apparatus 110 may lose the polling signal from the third apparatus 130, which can be determined by the first apparatus 110 based on measuring the signal strength of the polling signal from the third apparatus 130, e.g., if the signal strength of the polling signal from the third apparatus 130 does not satisfy a threshold.

At the time point T3, the first apparatus 110 may receive a polling signal 508 from the second apparatus 120. However, even if the first apparatus 110 determines that a measured signal strength of the polling signal 508 satisfies the threshold, the first apparatus 110 ignores (509) the polling signal 508 and does not send the polling response to the second apparatus 120 if a time to the next query time (e.g., at the time point T5) exceeds a predefined time, for example N polling cycles. Then the first apparatus 110 may continue receiving subsequent polling signal(s) and if the first apparatus 110 determines that a time to the next query time is less than a predefined time, the first apparatus 110 backscatters (513) a response 512 to the second apparatus 120 (e.g., at the time point T4). Then an attachment establishment (514) may be initiated between the first apparatus 110 and the second apparatus 120. In this way, the first apparatus 110 may recover the network attachment.

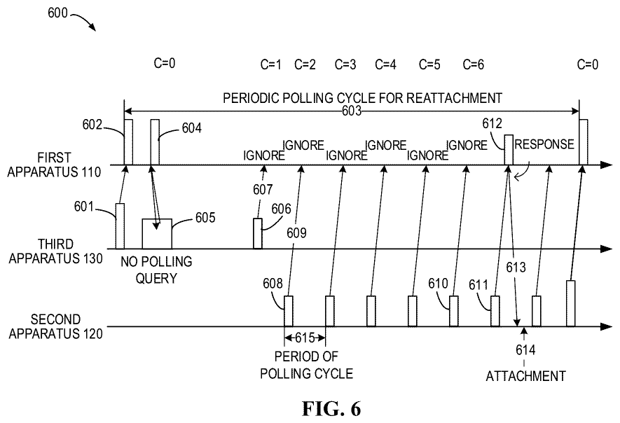

In some example embodiments, the first apparatus 110 may determine, based on the period of the query cycle, a subsequent query occasion of the first apparatus 110. Further, the first apparatus 110 may count a polling signal reception based on the period of the polling cycle of the polling signal. If the first apparatus 110 determines that a counted number of the polling signal reception reaches a predetermined value before the subsequent query occasion, the first apparatus 110 may initiate the attachment. The details will be described with reference to FIG. 6 below.

FIG. 6 illustrates an example 600 of counter-based attachment according to some example embodiments of the present disclosure. As shown in FIG. 6, the first apparatus 110 was attached with the third apparatus 130. A counter may be used to delay the establishment of (re)attachment to avoid frequent de-attachment/re-attachment between readers.

Specifically, the third apparatus 130 sends a query 601. The first apparatus 110 receives the query 601 and backscatters a query response 602. After the first apparatus 110 attaches with the third apparatus 130, the counter is set to 0. The first apparatus 110 needs to continuously receive polling signals.

For example, if the first apparatus 110 receives a polling signal 606 from the third apparatus 130, the counter is set to 1. Since a value of the counter does not reach a predetermined value, the first apparatus 110 ignores (607) the polling signal 606. Subsequently, after the first apparatus 110 receives a polling signal 608 from the second apparatus 120, the counter is set to 2. If the current value of the counter does not reach a predetermined value, the first apparatus 110 ignores (609) the polling signal 608. Until the first apparatus receives a polling signal 610 from the second apparatus 120 and the counter is set to 6, if the first apparatus 110 determines that the current value (e.g., 6) the counter reaches the predetermined value (i.e., 6), upon receiving the next polling signal 611, the first apparatus 110 backscatters (613) a response 612 to the second apparatus 120. Then an attachment establishment (614) may be initiated between the first apparatus 110 and the second apparatus 120. During the process, the first apparatus 110 may count a polling signal reception until a determination that the counter for the polling signal reception reaches the predetermined value before the time point T5.

In this way, the first apparatus 110 receives polling signals continuously, whether from the attached activator or other activators. The first apparatus 110 will receive a query message after receiving a fixed number of polling signals. After the first apparatus 110 is attached/re-attached with best activator, the counter is reset to 0. For each polling received, the counter increases by 1. When the configured maximum value (e.g., 6) is reached, the first apparatus 110 replies the “response” and initiates the re-attachment with network.

As compared to the example of the absolute time stamp-based attachment in FIG. 5, the example of the counter-based attachment in FIG. 6 does not need to add a time parameter to the polling signal.

From an aspect of the complexity a AIoT attachment, the most important guarantee for the implementation of the present disclosure is that the AIoT device needs to be capable of received signal strength measurement. That is to say, the complexity of the tag will be higher than that of RFID which also adopts the backscattering communication mode. Such energy harvesting devices can be used for some advanced use cases like agriculture, livestock monitoring.

As example mentioned above, the polling signal is a narrowband, low-rate signal in time domain. The strength of received signal may be measured in the analog domain. Compared with adding crystal oscillators, it will not significantly increase the cost and complexity in Application Specific Integrated Circuits (ASIC) design.

The AIoT device herein uses the backscattering communication, so it does not need the energy support of the battery, and therefore does not add a crystal oscillator to provide frequency and time reference. Like RFID, its cost and complexity still can remain very low.

Furthermore, the AIoT device based (re)attachment is high complexity as compared to passive network based reassociation but the AIoT device proactively measures signal receiving power from other activators and may attach with the activator actively when it is almost lost from the network. On the other hand, device based (re)attachment may involve lower signaling overhead and a shorter delay for information transfer than network based (re)attachment.

Therefore, based on the solution of the present disclosure, some high-end use cases requiring high complexity tags and some scenarios where the network needs to obtain the information of the AIoT device in a timely manner, such as agriculture, livestock, healthcare etc., can be achieved.

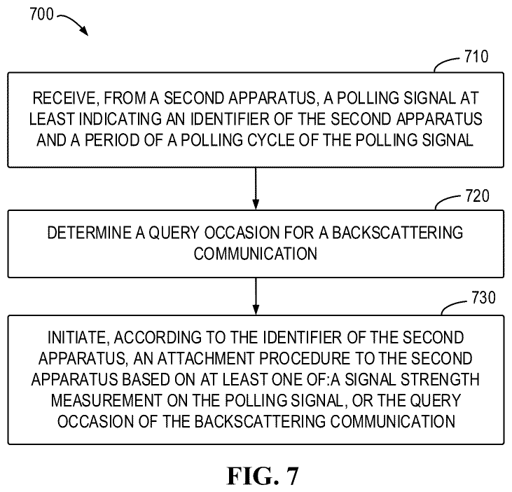

FIG. 7 shows a flowchart of an example method 700 implemented at a first apparatus in accordance with some example embodiments of the present disclosure. For the purpose of discussion, the method 700 will be described from the perspective of the first apparatus 110 (e.g., AIoT device) in FIG. 1.

At block 710, the first apparatus 110 receives, from a second apparatus, a polling signal at least indicating an identifier of the second apparatus and a period of a polling cycle of the polling signal, wherein the first apparatus enables a communication with the second apparatus by backscattering mechanism.

At block 720, the first apparatus 110 determines a query occasion for a backscattering communication.

At block 730, the first apparatus 110 initiates, according to the identifier of the second apparatus, an attachment procedure to the second apparatus based on at least one of: a signal strength measurement on the polling signal, or the query occasion of the backscattering communication.

In some example embodiments, the polling signal further indicates at least one of the following: an identifier of a cell associated with the second apparatus, a time reference, or an indication for requesting identification information of the first apparatus.

In some example embodiments, the method 700 further comprises: the first apparatus 110 sends a response to the second apparatus by, reporting identification information of the first apparatus to the second apparatus, and indicating an availability to receive a query message during the query occasion from the second apparatus.

In some example embodiments, the method 700 further comprises: the first apparatus 110, in accordance with a determination that a measured signal strength of the polling signal satisfies a threshold signal strength, initiates the attachment procedure to the second apparatus.

In some example embodiments, the method 700 further comprises: the first apparatus 110 measures a further signal strength of a further polling signal received from the third apparatus; and the first apparatus 110, in accordance with a determination that the measured signal strength satisfies a threshold signal strength and/or the further signal strength does not satisfy a further threshold signal strength, initiating the attachment.

In some example embodiments, the method 700 further comprises: in accordance with a determination that the further signal strength satisfies the further threshold signal strength, the first apparatus 110 maintains the attachment to the third apparatus. The threshold signal strength and the further threshold signal strength may be different or same.

In some example embodiments, the method 700 further comprises: the first apparatus 110 initiates the attachment procedure to the second apparatus based on the signal strength measurement on the polling signal and a period of a query cycle.

In some example embodiments, the method 700 further comprises: the first apparatus 110 determines, based on the period of the query cycle, a subsequent query occasion of the first apparatus; and the first apparatus 110, in accordance with a determination that a time interval between a current time point to the subsequent query occasion is less than a time duration of a predetermined number of the polling cycles, initiates the attachment.

In some example embodiments, the method 700 further comprises: the first apparatus 110 determines, based on the period of the query cycle, a subsequent query occasion of the first apparatus; the first apparatus 110 counts a polling signal reception based on the period of the polling cycle of the polling signal; and the first apparatus 110, in accordance with a determination that a counted number of the polling signal reception reaches a predetermined value before the subsequent query occasion, initiates the attachment.

In some example embodiments, the method 700 further comprises: the first apparatus 110 ignores the measured signal strength, in accordance with a determination that one of the following: the time interval between the current time point to the subsequent query occasion exceeds the time duration of the predetermined number of the polling cycles; or the counter for the polling signal reception does not reach the predetermined value.

In some example embodiments, the first apparatus comprises a ambient internet of things device and the second apparatus comprises a radio terminal device or a radio access network device.

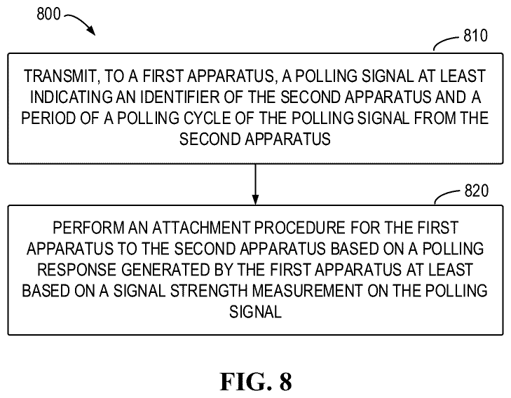

FIG. 8 shows a flowchart of an example method 800 implemented at a second apparatus in accordance with some example embodiments of the present disclosure. For the purpose of discussion, the method 800 will be described from the perspective of the second apparatus 120 (e.g., a UE or a gNB) in FIG. 1.

At block 810, the second apparatus 120 transmits, to a first apparatus, a polling signal at least indicating an identifier of the second apparatus and a period of a polling cycle of the polling signal from the second apparatus, wherein the first apparatus enables a communication with the second apparatus by an energy harvesting.

At block 820, the second apparatus 120 performs an attachment procedure for the first apparatus to the second apparatus based on a response generated by the first apparatus at least based on a signal strength measurement on the polling signal.

In some example embodiments, the polling signal further indicates at least one of the following: an identifier of a cell associated with the second apparatus, a time reference, or an indication for requesting identification information of the first apparatus.

In some example embodiments, the method 800 further comprises: the second apparatus 120, in accordance with a determination that the response indicating an initiation of the attachment procedure from the first apparatus to the second apparatus, performs the attachment procedure.

In some example embodiments, the first apparatus comprises a ambient internet of things device and the second apparatus comprises a radio terminal device or a radio access network device.

In some example embodiments, a first apparatus capable of performing any of the method 600 (for example, the first apparatus 110 in FIG. 1) may comprise means for performing the respective operations of the method 600. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a polling signal at least indicating an identifier of the second apparatus and a period of a polling cycle of the polling signal, wherein the first apparatus enables a communication with the second apparatus by backscattering mechanism; means for determining a query occasion for a backscattering communication; and means for initiating, according to the identifier of the second apparatus, an attachment procedure to the second apparatus based on at least one of: a signal strength measurement on the polling signal, or the query occasion of the backscattering communication.

In some example embodiments, the polling signal further indicates at least one of the following: an identifier of a cell associated with the second apparatus, a time reference, or an indication for requesting identification information of the first apparatus.

In some example embodiments, the first apparatus further comprises: means for sending a response to the second apparatus by, reporting identification information of the first apparatus to the second apparatus, and indicating an availability to receive a query message during the query occasion from the second apparatus.

In some example embodiments, the first apparatus further comprises: means for in accordance with a determination that a measured signal strength of the polling signal satisfies a threshold signal strength, initiating the attachment procedure to the second apparatus.

In some example embodiments, the first apparatus is attached with a third apparatus, and wherein the first apparatus further comprises: means for measuring a further signal strength of a further polling signal received from the third apparatus; and means for in accordance with a determination that the measured signal strength satisfies a threshold signal strength and/or the further signal strength does not satisfy a further threshold signal strength, initiating the attachment.

In some example embodiments, the first apparatus further comprises: means for in accordance with a determination that the further signal strength satisfies the further threshold signal strength, maintaining the attachment to the third apparatus. The threshold signal strength and the further threshold signal strength may be different or same.

In some example embodiments, the first apparatus further comprises: means for initiating the attachment procedure to the second apparatus based on the signal strength measurement on the polling signal and a period of a query cycle.

In some example embodiments, the first apparatus further comprises: means for determining, based on the period of the query cycle, a subsequent query occasion of the first apparatus; and means for in accordance with a determination that a time interval between a current time point to the subsequent query occasion is less than a time duration of a predetermined number of the polling cycles, initiating the attachment.

In some example embodiments, the first apparatus further comprises: means for determining, based on the period of the query cycle, a subsequent query occasion of the first apparatus; means for counting a polling signal reception based on the period of the polling cycle of the polling signal; and means for in accordance with a determination that a counted number of the polling signal reception reaches a predetermined value before the subsequent query occasion, initiating the attachment.

In some example embodiments, the first apparatus further comprises: means for ignoring the measured signal strength, in accordance with a determination that one of the following: the time interval between the current time point to the subsequent query occasion exceeds the time duration of the predetermined number of the polling cycles; or the counter for the polling signal reception does not reach the predetermined value.

In some example embodiments, the first apparatus comprises a ambient internet of things device and the second apparatus comprises a radio terminal device or a radio access network device.

In some example embodiments, the first apparatus further comprises means for performing other operations in some example embodiments of the method 700 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 800 (for example, the second apparatus 120 in FIG. 1) may comprise means for performing the respective operations of the method 800. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a polling signal at least indicating an identifier of the second apparatus and a period of a polling cycle of the polling signal from the second apparatus, wherein the first apparatus enables a communication with the second apparatus by an energy harvesting; and means for performing an attachment procedure for the first apparatus to the second apparatus based on a response generated by the first apparatus at least based on a signal strength measurement on the polling signal.

In some example embodiments, the polling signal further indicates at least one of the following: an identifier of a cell associated with the second apparatus, a time reference, or an indication for requesting identification information of the first apparatus.

In some example embodiments, the second apparatus further comprises: means for in accordance with a determination that the response indicating an initiation of the attachment procedure from the first apparatus to the second apparatus, performing the attachment procedure.

In some example embodiments, the first apparatus comprises a ambient internet of things device and the second apparatus comprises a radio terminal device or a radio access network device.

In some example embodiments, the second apparatus further comprises means for performing other operations in some example embodiments of the method 800 or the second apparatus 120. In some example embodiments, the means comprises at least one processor; and at least one memory storing instructions that, when executed by the at least one processor, cause the performance of the second apparatus.

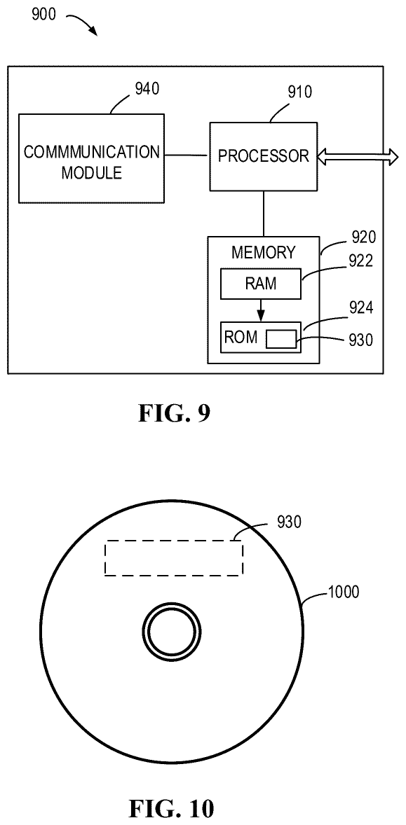

FIG. 9 is a simplified block diagram of a device 900 that is suitable for implementing example embodiments of the present disclosure. The device 900 may be provided to implement a communication device, for example, the first apparatus 110 or the second apparatus 120 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 2 to FIG. 9. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-20. (canceled)

21. A first apparatus comprising:
at least one processor; and
at least one memory storing instructions that, when executed by the at least one processor, cause the first apparatus at least to:
receive, from a second apparatus, a polling signal at least indicating an identifier of the second apparatus and a period of a polling cycle of the polling signal, wherein the first apparatus enables a communication with the second apparatus by backscattering mechanism;
determine a query occasion for a backscattering communication; and
initiate, according to the identifier of the second apparatus, an attachment procedure to the second apparatus based on at least one of:
a signal strength measurement on the polling signal, or
the query occasion of the backscattering communication.

22. The first apparatus of claim 21, wherein the polling signal further indicates at least one of the following:
an identifier of a cell associated with the second apparatus,
a time reference, or
an indication for requesting identification information of the first apparatus.

23. The first apparatus of claim 21, wherein the first apparatus is caused to initiate the attachment procedure by:
sending a response to the second apparatus by,
reporting identification information of the first apparatus to the second apparatus, and
indicating an availability to receive a query message during the query occasion from the second apparatus.

24. The first apparatus of claim 21, wherein the first apparatus is caused to:
in accordance with a determination that a measured signal strength of the polling signal satisfies a threshold signal strength, initiate the attachment procedure to the second apparatus.

25. The first apparatus of claim 21, wherein the first apparatus is attached with a third apparatus, and wherein the first apparatus is caused to:
measure a further signal strength of a further polling signal received from the third apparatus; and
in accordance with a determination that the measured signal strength satisfies a threshold signal strength and/or the further signal strength does not satisfy a further threshold signal strength, initiating the attachment.

26. The first apparatus of claim 25, wherein the first apparatus is caused to:
in accordance with a determination that the further signal strength satisfies the further threshold signal strength, maintain the attachment to the third apparatus.

27. The first apparatus of claim 21, wherein the first apparatus is caused to:
initiate the attachment procedure to the second apparatus based on the signal strength measurement on the polling signal and a period of a query cycle.

28. The first apparatus of claim 27, wherein the first apparatus is caused to:
determine, based on the period of the query cycle, a subsequent query occasion of the first apparatus; and
in accordance with a determination that a time interval between a current time point to the subsequent query occasion is less than a time duration of a predetermined number of the polling cycles, initiate the attachment.

29. The first apparatus of claim 27, wherein the first apparatus is caused to:
determine, based on the period of the query cycle, a subsequent query occasion of the first apparatus;
count a polling signal reception based on the period of the polling cycle of the polling signal; and
in accordance with a determination that a counted number of the polling signal reception reaches a predetermined value before the subsequent query occasion, initiate the attachment.

30. The first apparatus of claim 28, wherein the first apparatus is caused to:
ignore the measured signal strength, in accordance with a determination that one of the following:
the time interval between the current time point to the subsequent query occasion exceeds the time duration of the predetermined number of the polling cycles; or
the counter for the polling signal reception does not reach the predetermined value.

31. The first apparatus of claim 21, wherein the first apparatus comprises a ambient internet of things device and the second apparatus comprises a radio terminal device or a radio access network device.

32. A second apparatus comprising:
at least one processor; and
at least one memory storing instructions that, when executed by the at least one processor, cause the second apparatus at least to:
transmit, to a first apparatus, a polling signal at least indicating an identifier of the second apparatus and a period of a polling cycle of the polling signal from the second apparatus, wherein the first apparatus enables a communication with the second apparatus by an energy harvesting; and
perform an attachment procedure for the first apparatus to the second apparatus based on a response generated by the first apparatus at least based on a signal strength measurement on the polling signal.

33. The second apparatus of claim 32, wherein the polling signal further indicates at least one of the following:
an identifier of a cell associated with the second apparatus,
a time reference, or
an indication for requesting identification information of the first apparatus.

34. The second apparatus of claim 32, wherein the second apparatus is caused to:
in accordance with a determination that the response indicating an initiation of the attachment procedure from the first apparatus to the second apparatus, perform the attachment procedure.

35. The second apparatus of claim 32, wherein the first apparatus comprises a ambient internet of things device and the second apparatus comprises a radio terminal device or a radio access network device.

36. A first apparatus comprising:
means for receiving, from a second apparatus, a polling signal at least indicating an identifier of the second apparatus and a period of a polling cycle of the polling signal, wherein the first apparatus enables a communication with the second apparatus by backscattering mechanism;
means for determining a query occasion for a backscattering communication; and
means for initiating, according to the identifier of the second apparatus, an attachment procedure to the second apparatus based on at least one of:
a signal strength measurement on the polling signal, or
the query occasion of the backscattering communication.
